(19) United States
(12) Patent Application Publication
(10) Pub. No.: US 2021/0084027 A1
(43) Pub. Date: Mar. 18, 2021

(54) A Digitally Certified Ecosystem

(71) Applicant: Nigel Luke JOHNSTON, New South Wales (AU)

(72) Inventor: Nigel Luke JOHNSTON, New South Wales (AU)

(21) Appl. No.: 16/641,090

(22) PCT Filed: Aug. 21, 2018
(86) PCT No.: PCT/AU2018/050888

§ 371 Date: Feb. 21, 2020

(30) Foreign Application Priority Data
Aug. 21, 2017 (AU) 2017903365

(51) Int. Cl. H04L 29/06; G06F 16/955

(52) U.S. Cl. CPC H04L 63/0823; G06F 16/955; H04L 63/123; H04L 63/126

(57) ABSTRACT

A digitally certified ecosystem includes a plurality of verifying entities and a plurality of verified entities, each verified entity verified according to at least one aspect of the entity by at least one of the verifying entities. The digitally certified ecosystem further includes an issuing system server which enables a secure communications mode on a website of a verified entity.

### TECHNICAL FIELD

The present invention relates to apparatus and a methodology for signalling accreditation status and, more particularly although not exclusively, to such an apparatus and methodology implemented by way of a secured environment.

### BACKGROUND

It is known for equipment and/or its production methodology to be tested to a specified technical standard.

Historically, such testing and certification results in issue of a certificate or other paper based accreditation.

It will be helpful if the testing and/or notification of reaching a specified technical standard could be signalled by way of an automated electronic signalling arrangement.

A particular issue relates to how to fully incorporate a market place system into a digital environment and take advantage of digital certification capabilities to improve the certainty that potential buyers within the market place may have as to the nature, quality and identity of the entities with which they may seek to deal.

It is an object of the present invention to address or at least ameliorate some of the above disadvantages.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

### Definitions

In this specification the terms certified” or “verified” are used interchangeably.

Below is described a “certification” process which results in the creation of “certified” or “verified” entities within a digitally certified ecosystem.

Accordingly, in one broad form of the invention, there is provided a digitally certified ecosystem comprising a plurality of verifying entities and a plurality of verified entities; each verified entity verified according to at least one aspect of the entity by at least one of the verifying entities.

Accordingly, in a further broad form of the invention, there is provided a digitally certified ecosystem comprising a plurality of verifying entities and a plurality of verified entities; each verified entity verified according to at least one aspect of the entity by at least one of the verifying entities; the digitally certified ecosystem further comprising an issuing system server which enables a secure communications mode on a website of a verified entity.

Accordingly, in a further broad form of the invention, there is provided a method of digitally certifying members of an ecosystem; said system comprising a plurality of verifying entities and a plurality of verified entities; the method incorporating steps whereby each verified entity is verified according to at least one aspect of the entity by at least one of the verifying entities;

Accordingly, in a further broad form of the invention, there is provided a method of digitally certifying members of an ecosystem; said system comprising a plurality of verifying entities and a plurality of verified entities; the method incorporating steps whereby each verified entity is verified according to at least one aspect of the entity by at least one of the verifying entities; the digitally certified ecosystem further comprising an issuing system server which enables a secure communications mode on a website of a verified entity.

Preferably each verified entity is digitally certified by the issue of a certificate for use in association with a web address of the verified entity.

Preferably the certificate is an SSL certificate issued by an SSL conforming platform.

Preferably the certificate is a TLS certificate issued by a TLS platform.

Preferably digital certification of each verified entity is signalled by a characterising image.

Preferably the characterising image is displayed in the address bar of a webpage of the website of the verified entity.

Preferably a code snippet is issued to a webpage of the web address; the code snippet, when executed by the browser of the verified entity, implementing an active image for display on the webpage of that verified entity.

Preferably the verifying entities are in a hierarchical structure.

Preferably the step of digital certification includes issue of an entity ID.

Preferably the step of digital certification includes issue of an aspect pass identifier.

Preferably the code snippet includes code which, when executed by the browser of the verified entity, causes display of data in a drop-down table.

Preferably display of data in a drop-down table occurs when a mouse pointer is hovered over the characterising image.

Preferably display of data in a drop-down table occurs when a mouse pointer is hovered over the active image.

Preferably the data in the drop-down table includes the entity ID.

preferably the data in the drop-down table includes the aspect pass identifier.

Preferably the issuing system server maintains a database containing at least the entity ID and the aspect pass identifier of each verified entity.

Preferably the database is maintained in a block chain structure.

Preferably code is made available for installation on a digital device mandated to be used by an auditor of an entity to be verified.

Preferably the digital device includes GPS capability.

Preferably the code utilises the GPS capability to track and auditor during an audit and to make data pertaining to the tracking action available to the verifier 104 which instigated the installation of the code.

In yet a further broad form of the invention there is provided a digital marketplace comprising a website served by a web enabled server in which only entities comprising verified entities in accordance with the system of any one of claims 1 to 20 may participate.

In a further broad form of the invention of the above described system is implemented by way of a processor in communication with a memory; the memory containing code which, when executed, performs the function of the issuing system server.

In yet a further broad form of the invention there is provided media containing code which, when executed by a processor, implements the above described system.

In yet a further broad form of the invention there is provided a digital input/output device incorporating means to implement the system or method as described above.

Preferably the device is implemented as a software application on a smart phone.

In yet a further broad form of the invention there is provided a medium storing code thereon which, when executed by a processor, effects the system or method as described above.

Preferably the medium is a non-transitory medium.

In yet a further broad form of the invention there is provided a digital input/output device incorporating means to recognize a physiological feature preparatory to transferring data in accordance with the system or method as described above.

Preferably the device is implemented as a software application on a smart phone.

### BRIEF DESCRIPTION OF DRAWINGS

Embodiments of the present invention will now be described with reference to the accompanying drawings wherein:

FIG. 1 is a block diagram of a digitally certified ecosystem in accordance with a first embodiment;

FIG. 2 is a screenshot of the signalling output of the system of FIG. 1;

FIG. 3 is a flow chart of the logic of the ecosystem of FIG. 1;

FIG. 4 is a diagram of an exemplary block chain data structure usable with the above described embodiments;

FIG. 5 illustrates diagrammatically use of the block chain data structure of FIG. 4.

FIG. 6 illustrates a block chain enablement of the arrangement of FIG. 1.

FIG. 7 is a block diagram of a digitally certified ecosystem illustrating a use scenario for any of the above described embodiments and illustrating interlinking of the components making up the system.

### DESCRIPTION OF EMBODIMENTS

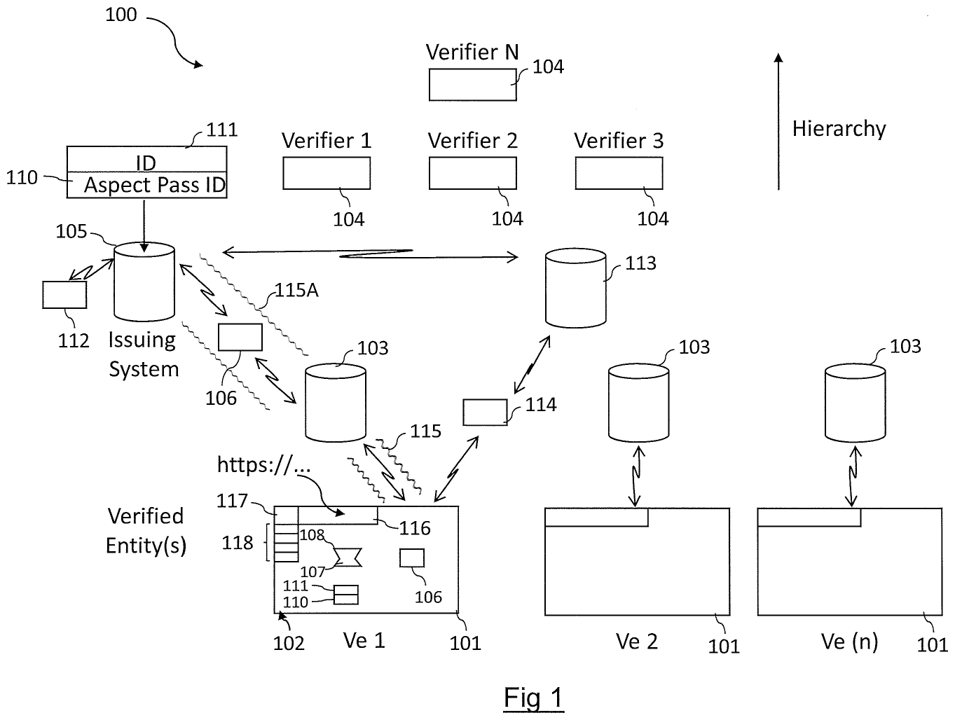

With reference to FIG. 1 there is disclosed a block diagram of a digitally certified ecosystem 100 in accordance with the first embodiment.

In this arrangement a first verified entity 101 is represented by way of a webpage 102 which is served by a web server 103. The verified entity 101 will have been verified by a verifier 104 to the effect that some aspect of the operation of the verified entity 101 or the products which it manufactures or the services which it offers has been verified as meeting a predetermined standard as determined by the verifier 104 following a test sequence applied by verifier 104 to the aspect.

If the aspect passes the test the verifier communicates the identity of the entity and the aspect pass identity to an issuing system 105.

The issuing system generates a secure certificate 112 which is communicated to the server 103 for installation on the digital device which executes the webpage 102 of entity 101. The certificate 112 is issued under the aegis of an operating system certificate issuer 113.

The operating system of the digital device executing webpage 102 receives permission certificate code 114 from the operating system certificate issuer 113 which thereby enables the operating system, on receipt of the secured certificate 112 to cause the webpage 102 to operate within a secure tunnel 115 at least as between webpage 102 and server 103. The tunnel operation is visually indicated in the address bar 116 of webpage 102. In a preferred form the operation includes a display of a characterising image 117. In a preferred form the characterising image is characteristic of verifications issued by any of the verifiers 104.

In a preferred form if the mouse pointer is made to hover over the address bar 116 a drop down menu 118 is caused to appear. The drop down menu can include the entity ID 111 and/or the aspect pass identifier 110.

By this mechanism the webpage and data of webpage 102 is secured at least as between webpage 102 and server 103. In addition a viewer of the webpage 102 is notified of the certification of the aspect of the entity 101. In preferred forms the secure tunnel 115 extends as tunnel 115 A between the server of issuing system 105 and server 103.

In addition or in the alternative the issuing system generates a code snippet 106 for transmission to server 103. Server 103 installs the code snippet, in a preferred form, in a browser window or webpage 102 wherein, upon execution of the snippet 106 an active image 107 is generated for display on webpage 102. The active image 107 displays a visual indicator 108. In addition if a mouse pointer is caused to hover over the active image 107 a drop down menu 109 is caused to be displayed on the webpage 102. The menu can include details such as the aspect pass identifier 110 and/or the entity identifier 111 as issued by the verifier 104.

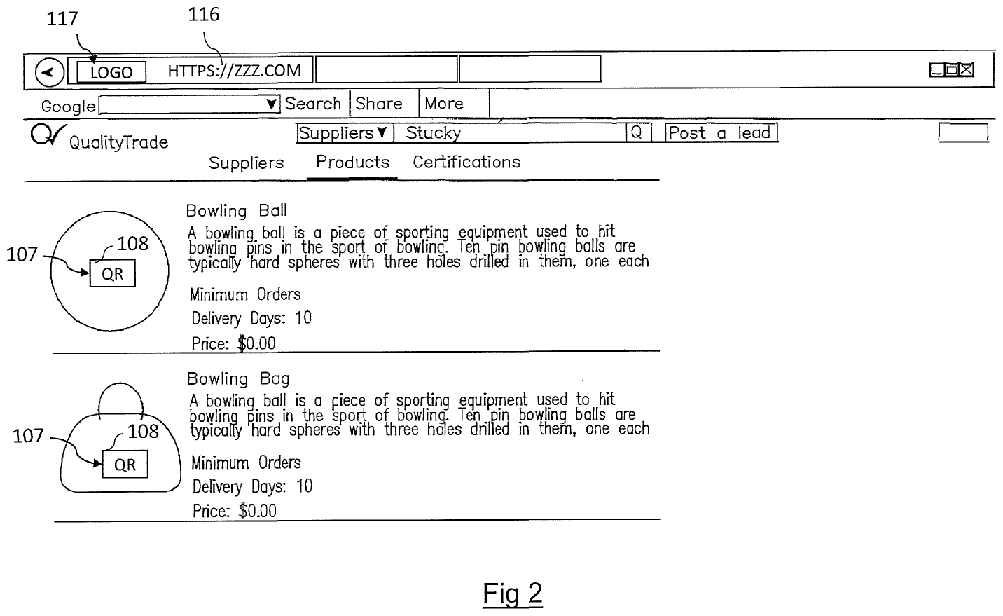

With reference to the screenshot of FIG. 2 the address bar 116, in this instance, shows a secure address as https://zzz.com. In addition a characterising image 117 issued by the verifier 104 is shown juxtaposed to the secure address.

Individual items for sale via the webpage 102 may include an active image 107 juxtaposed to data concerning the item. In particular instances the active image 107 may include a visual indicator 108 for example in the form of a QR code.

### TLS and SSL

The address bar 116 reflects the setting up of a secure channel 115 between the browser illustrating the webpage 102 and server 103. In preferred forms the channel is specific to the verifier 104. In alternative instances the channel reflects certification conferred in communication with multiple verifiers. In further preferred forms it reflects certification confirmed in communication with multiple verifiers, the verifiers formed in a communications hierarchy as illustrated in FIG. 1. The certification is signalled by way of the address bar 116. In preferred forms this include signalling by way of the characterising image 117.

In some instances the same characterising image 117 is utilised as a substantial portion of the active image 107.

By way of background the following paragraphs reproduced from Wikipedia describe transport layer security (TLS) technology and its implementation. As described above preferred forms make use of this technology to provide a secure channel for communication of the contents of the address bar 116 and for transmission of the characterising image 117.

Transport Layer Security (TLS) and its predecessor, Secure Sockets Layer (SSL), both frequently referred to as “SSL”, are cryptographic protocols that provide communications security over a computer network.[1] Several versions of the protocols find widespread use in applications such as web browsing, email, Internet faxing, instant messaging, and voice-over-IP (VoIP). Websites are able to use TLS to secure all communications between their servers and web browsers.

The Transport Layer Security protocol aims primarily to provide privacy and data integrity between two communicating computer applications.[1]:3 When secured by TLS, connections between a client (e.g., a web browser) and a server (e.g., wikipedia.org) have one or more of the following properties:

The connection is private (or secure) because symmetric cryptography is used to encrypt the data transmitted. The keys for this symmetric encryption are generated uniquely for each connection and are based on a shared secret negotiated at the start of the session (see TLS handshake protocol). The server and client negotiate the details of which encryption algorithm and cryptographic keys to use before the first byte of data is transmitted. The negotiation of a shared secret is both secure (the negotiated secret is unavailable to eavesdroppers and cannot be obtained, even by an attacker who places themselves in the middle of the connection) and reliable (no attacker can modify the communications during the negotiation without being detected).

The identity of the communicating parties can be authenticated using public-key cryptography. This authentication can be made optional, but is generally required for at least one of the parties (typically the server).

The connection ensures integrity because each message transmitted includes a message integrity check using a message authentication code to prevent undetected loss or alteration of the data during transmission.

In addition to the properties above, careful configuration of TLS can provide additional privacy-related properties such as forward secrecy, ensuring that any future disclosure of encryption keys cannot be used to decrypt any TLS communications recorded in the past.

### DESCRIPTION

Client-server applications use the TLS protocol to communicate across a network in a way designed to prevent eavesdropping and tampering.

Since applications can communicate either with or without TLS (or SSL), it is necessary for the client to indicate to the server the setup of a TLS connection.[5] One of the main ways of achieving this is to use a different port number for TLS connections, for example port 443 for HTTPS. Another mechanism is for the client to make a protocol-specific request to the server to switch the connection to TLS; for example, by making a STARTTLS request when using the mail and news protocols.

Once the client and server have agreed to use TLS, they negotiate a stateful connection by using a handshaking procedure.[6] The protocols use a handshake with an asymmetric cipher to establish cipher settings and a shared key for a session; the rest of the communication is encrypted using a symmetric cipher and the session key. During this handshake, the client and server agree on various parameters used to establish the connection's security:

The handshake begins when a client connects to a TLS-enabled server requesting a secure connection and the client presents a list of supported cipher suites (ciphers and hash functions).

From this list, the server picks a cipher and hash function that it also supports and notifies the client of the decision.

The server usually then sends back its identification in the form of a digital certificate. The certificate contains the server name, the trusted certificate authority (CA) and the server's public encryption key.

The client confirms the validity of the certificate before proceeding.

To generate the session keys used for the secure connection, the client either: encrypts a random number with the server's public key and sends the result to the server (which only the server should be able to decrypt with its private key); both parties then use the random number to generate a unique session key for subsequent encryption and decryption of data during the session uses Diffie-Hellman key exchange to securely generate a random and unique session key for encryption and decryption that has the additional property of forward secrecy: if the server's private key is disclosed in future, it cannot be used to decrypt the current session, even if the session is intercepted and recorded by a third party.

This concludes the handshake and begins the secured connection, which is encrypted and decrypted with the session key until the connection closes. If any one of the above steps fail, the TLS handshake fails, and the connection is not created.

TLS and SSL do not fit neatly into any single layer of the OSI model or the TCP/IP model. TLS runs “on top of some reliable transport protocol (e.g., TCP), which would imply that it is above the transport layer. It serves encryption to higher layers, which is normally the function of the presentation layer. However, applications generally use TLS as if it were a transport layer,[7][8] even though applications using TLS must actively control initiating TLS handshakes and handling of exchanged authentication certificates.

### Applications and Adoption

In applications design, TLS is usually implemented on top of Transport Layer protocols, encrypting all of the protocol-related data of protocols such as HTTP, FTP, SMTP, NNTP and XMPP.

Historically, TLS has been used primarily with reliable transport protocols such as the Transmission Control Protocol (TCP). However, it has also been implemented with datagram-oriented transport protocols, such as the User Datagram Protocol (UDP) and the Datagram Congestion Control Protocol (DCCP), usage of which has been standardized independently using the term Datagram Transport Layer Security (DTLS).

### Websites

A prominent use of TLS is for securing World Wide Web traffic between a website and a web browser encoded with the HTTP protocol. This use of TLS to secure HTTP traffic constitutes the HTTPS protocol.

In this instance and as described above preferred forms make use of this technology to provide a secure channel for communication of the contents of the address bar 116 and for transmission of the characterising image 117.

### Flow Chart

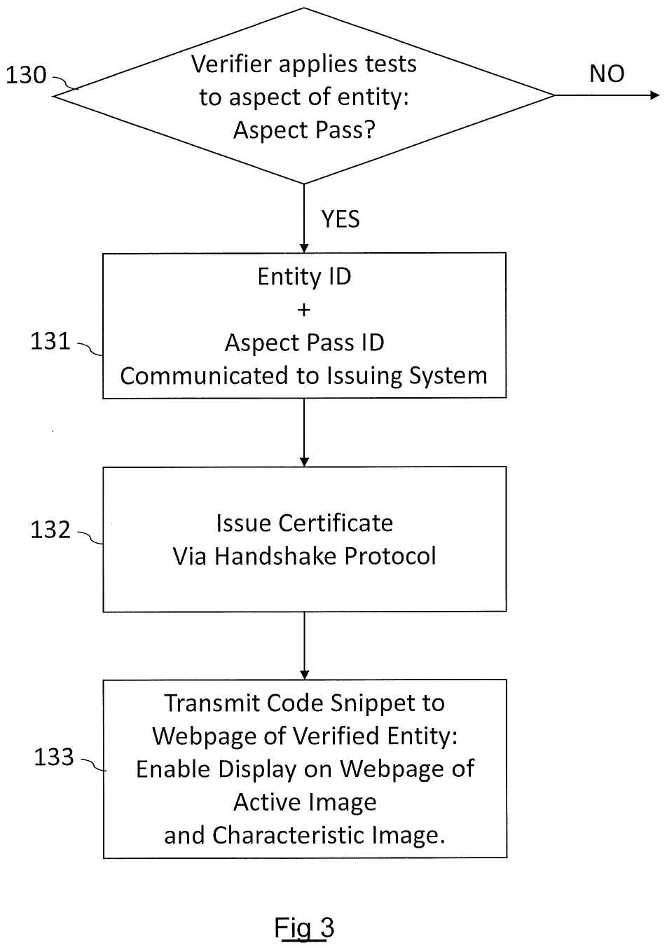

With reference to FIG. 3 as there is illustrated a flow chart for a setting up of a verified entity.

Initially a verifier applies tests to aspects of an entity at step 130. If the entity asks those tests then an entity ID and an aspect pass ID are communicated to an issuing system shown in block 131.

A certificate is then issued to the verified entity at block 132 such that its webpage 102 is enabled in the manner described above in relation to secure channel and display in address bar 116 and display of the active image 107 and the characterising image 117. The preferred forms for certificate issue involve the following steps when implemented utilising TLS technology:

Once the client 101 and server 103 have agreed to use TLS, they negotiate a stateful connection by using a handshaking procedure. The protocols use a handshake with an asymmetric cipher to establish cipher settings and a shared key for a session; the rest of the communication is encrypted using a symmetric cipher and the session key. During this handshake, the client and server agree on various parameters used to establish the connection's security:

The handshake begins when a client connects to a TLS-enabled server requesting a secure connection and the client presents a list of supported cipher suites (ciphers and hash functions).

From this list, the server picks a cipher and hash function that it also supports and notifies the client of the decision.

The server usually then sends back its identification in the form of a digital certificate. The certificate contains the server name, the trusted certificate authority (CA) and the server's public encryption key. The digital certificate, in preferred forms is issued by server 113.

The client confirms the validity of the certificate before proceeding.

To generate the session keys used for the secure connection, the client either:
encrypts a random number with the server's public key and sends the result to the server (which only the server should be able to decrypt with its private key); both parties then use the random number to generate a unique session key for subsequent encryption and decryption of data during the session
uses Diffie-Hellman key exchange to securely generate a random and unique session key for encryption and decryption that has the additional property of forward secrecy: if the server's private key is disclosed in future, it cannot be used to decrypt the current session, even if the session is intercepted and recorded by a third party.

This concludes the handshake and begins the secured connection between server 103 and webpage 102, which is encrypted and decrypted with the session key until the connection closes. Items are displayed and the code snippet is transmitted within the channel 115 implemented via the above steps as shown in box 133.

### AI Structures

AI (Artificial Intelligence) structures may be used to advantage with any of the above described embodiments.

In particular ‘Big Data’ aspects of AI may be used to advantage as the data set available to the system grows.

In one particular application the data set may be used by the system in order to determine to a predetermined level of certainty that a member meets the accepted quality standard.

In addition rankings can be determined. The rankings can then be utilized to determine which members are performing best in meeting predetermined quality standard.

### Block Chain Structures

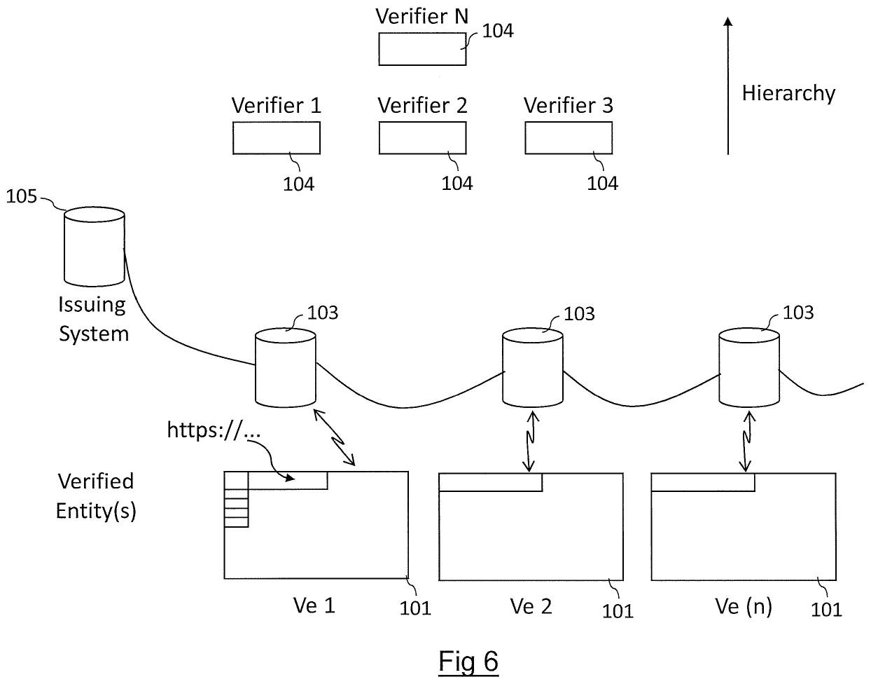

Blockchain structures may be used to advantage with any of the above described embodiments. In a preferred form the issuing system 105 may store data in a block chain environment and each verifier 104 can enter data associated with certification of any given entity and aspects of that entity. A block chain enablement of the arrangement of FIG. 1 is shown in FIG. 6.

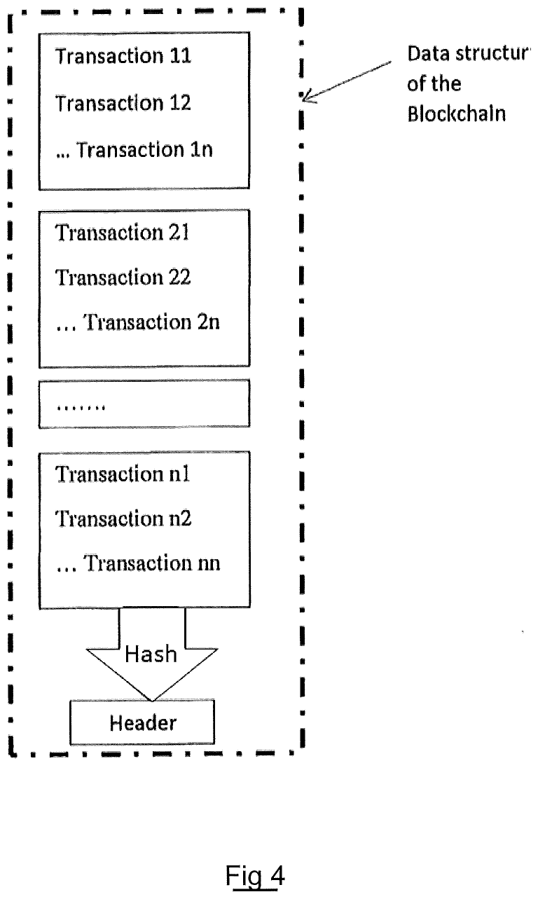

FIG. 4 is a diagram of an exemplary block chain data structure.

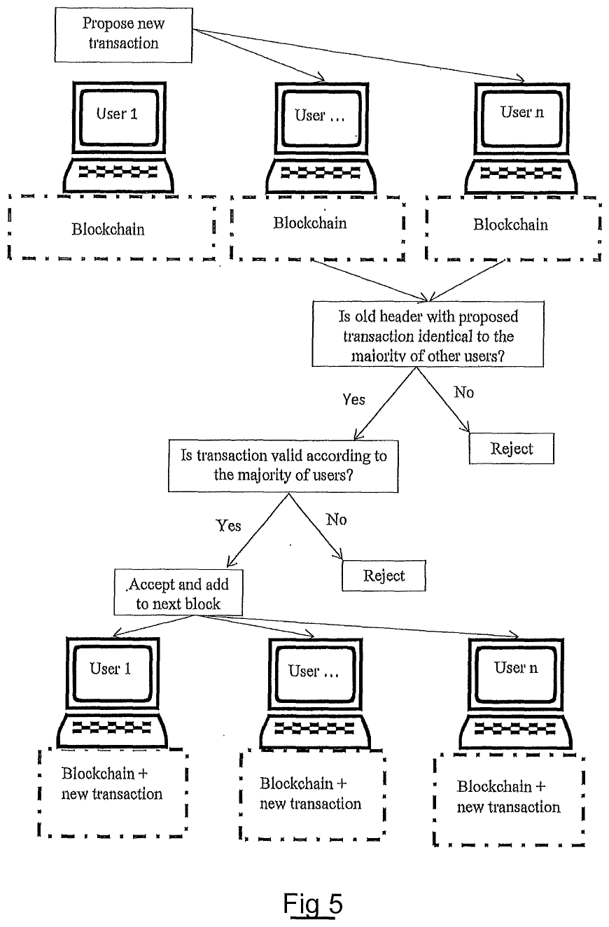

FIG. 5 illustrates diagrammatically use of the block chain data structure of FIG. 4.

With reference to FIGS. 4 and 5, Blockchain is a data structure and distributed record system, which seeks to provide a data structure and system which maintains a complete record of all transactions and minimizes risk of retrospective alterations, or double or identical transactions.

The data structure consists of a series of transactions grouped in blocks, which need to be verified before they are added to the chain. Rules may be set so no data is ever deleted, with the longest chain being taken to be the most recent, and so the chain records all transactions from its initiation in chronological order.

A copy of the chain is kept by all users, and so is a distributed record system. Before any transactions are added the majority of the users need to agree that the transaction is acceptable and then it is bundled with other acceptable transactions into a block, which is added to the chain. Each block has a header which can only be created knowing all the previous transactions. As a result, if a retrospective alteration is made the header will be incorrect and any new block proposed by that user will be rejected. The security of the system is further enhanced by having mathematical problems that can only be solved by trial and error, which use the header and must be solved and then verified by the majority of other users before a block is accepted into the chain by all users. As long as there are more genuine users than coordinated attackers trying to alter the chain then the chain will be secure. There may be other methods used to determine the veracity of a block of data, this may include voting or consent processes where parties with a stake in the transaction or related transactions or in the chain itself are granted ‘voting’ rights. Another process may involve a random or systematized voting or approval system where the validity of the block of data is approved in accordance with a set of protocols agreed by those with a stake in the veracity of the chain of data.

In a more particular form, each block includes verified transactions and the blockchain maintains a ledger all prior transactions. The blockchain is duplicated by all the computers on a network.

The first block in the chain is known as the Genesis block and new blocks can be added in linear and chronological order. From any given block in the chain the information of this genesis block and all blocks that led back to this one can be retrieved. A blockchain is essentially numerous blocks connected through hash chaining where each block is comprised of the following
Timestamp: provides proof that the data in a block existed at a particular time
Previous Hash: Essentially a pointer to the previous block
Merkle Hash: Summary of all executed transactions
Nonce: Individual blocks identity and is an arbitrary number which can only be used once.

The blockchain is managed by a network of distributed nodes where each node contains a copy of the entire blockchain. Each node in the network can add blocks to the chain, where every node is adding blocks at the same point in the chain at the same time. The more nodes that comprise the network the harder it is to disrupt the storage of the blockchain. Unlike centralised systems which rely on a single authority, there is no single point of failure in these distributed nodes network. If you change the content of a block you change its Hash.

A block chain enablement of the arrangement of FIG. 1 is shown in FIG. 6.

### In Use

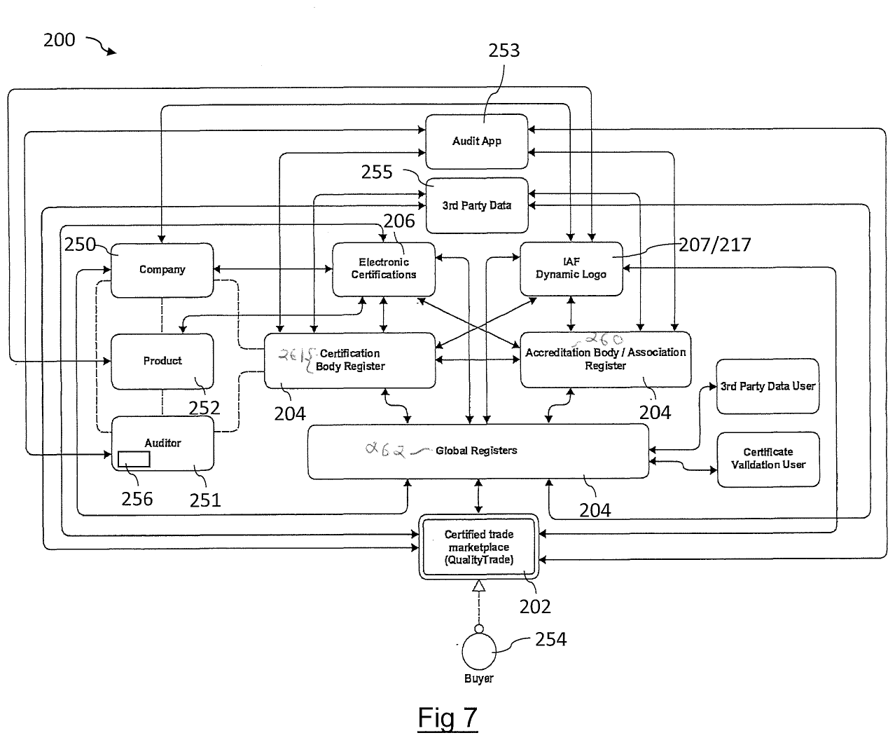

FIG. 7 is a block diagram of a digitally certified ecosystem illustrating a use scenario for any of the above described embodiments and illustrating interlinking of the components making up the system. Like components are numbered as for the embodiments described with reference to FIGS. 1 and 2 except in the 200 series.

The arrangement of FIG. 7 provides a detailed use scenario and illustrates the interlinking of the various components forming a digitally certified ecosystem in accordance with embodiments of the invention.

Broadly, a company 250 is audited by an auditor 251 thereby to be certified in relation to a product 252 or products (or services) which it makes to a standard sufficient to receive accreditation by at least one of the hierarchically organised verifiers 204 thereby resulting in issue of an electronic certification 206. In preferred forms the process includes use of an audit application 253.

Upon electronic certification or verification the company 250 is entitled and enabled to display a dynamic logo 207/217 on its website 202 which may be one of multiple websites from companies 250 which have been certified and are thereby entitled to enable use of the dynamic logo 207/217 on their webpages and/or on product services which may be placed together for offering in the marketplace 202 and from which buyers 254 may select.

Broadly, all of the following components as illustrated in FIG. 7 link in one way or another feeding data in a multipath, interlinked manner as illustrated to form a digital ecosystem 200 which enables reliable certification of companies worldwide and further permits those companies 250 once so certified or verified exclusively to participate in a certified trade marketplace 202 whereby buyers 254 are signalled as to the certification of each of the companies participating in the certified trade marketplace 202.

Product/Company 250

Electronic certification 206. The certifications can be performed by the audit app 253.

Dynamic logo 207/217: the dynamic logo 207/217 comprises one or more of the characterising image 117 and active image 107 of previously described embodiments.

Certification body electronic register 204: This register retains data for the Certification Body 261.

Accreditation body electronic register 204: This register retains data for the Accreditation Body 260.

Electronic Global register 204: This register retains data for the Global registers 262.

Global/Certified Trade Online Marketplace 202

The certified trade marketplace 202 comprises a website in which the verified entities 101 (and only the verified entities 101) may participate. This digital marketplace permits the verified entities 101 to offer their services or goods within a single digital environment and where the buyers 254 and, indeed, the certification bodies, accreditation bodies and global registering bodies 204 may have confidence as to the level of accreditation/verification reached by all participants on the marketplace 202.

Audit App 253

The audit app 253 in a preferred form is executable code 256 for installation on a smart device used by auditor 251 in the course of an audit of a company 250 in relation to its capacity to produce a product or service 252. The code 256, when loaded, permits verification data deriving from verification functions such as logging of data concerning location of the audit, the length of the audit to be transmitted to the body 204 which has instigated the installation of the executable code. By this mechanism the body receives an assurance in digital form that the audit took place and the level of thoroughness of the audit. The installation of the code 256 may be instigated by, for example, the Accreditation Body in order to provide an audit of the auditor 251 commissioned by the Certification Body. In preferred forms the smart device may be a smart phone or may be a tablet or other digital device. Capabilities of such devices which can be utilised include GPS tracking capability, digital data transmission capability and timing functions.

In one form the audit app 253 can be utilized by the Accreditation Body 260 to audit the Certification Body 261.

In a further form the audit app 253 can be utilized by the Certification Body 261 to audit the Verified Entity 101.

In a further form the audit app 253 can be utilized by the Verified Entity 101 to audit itself.

This “certification” process results in the creation of “certified” or “verified” entities.

In all instances the audit app 253 assists in the provision of evidence based data for the audit process.

In one form the audit app 253 may be implemented on a digital input/output device incorporating means to recognize a physiological feature preparatory to transferring data in accordance with the methodology described above.

In a particular form the digital input/output device is a smart phone.

In a further particular form the smart phone may be an Apple iPhone X available from the Apple Corporation, this particular device incorporating face recognition technology by which a face recognition step is utilized in place of password or other authentication process.

Electronic 3rd Party Data 255

Electronic third party data 255 comprises data made available to anyone of the entities operating within the ecosystem 200 derived from any one of the other entities operating within the ecosystem 200, thereby allowing corroboration and interlinking as described above with a view to enhancing confidence in the certification process.

Electronic Buyers 254 of Marketplace 202

The above describes only some embodiments of the present invention and modifications, obvious to those skilled in the art, can be made thereto without departing from the scope of the present invention.

### INDUSTRIAL APPLICATION

Embodiments of the invention, as described byway of example above may be utilised with advantage to permit multiple certifying authorities to work in association with each other to issue digital certifications which can be readily recognised on the web page of an entity so certified by one or more of the certifying authorities.

1. A digitally certified ecosystem comprising a plurality of verifying entities and a plurality of verified entities; each verified entity verified according to at least one aspect of the entity by at least one of the verifying entities; the digitally certified ecosystem further comprising an issuing system server which enables a secure communications mode on a website of a verified entity.

2. The system of claim 1 wherein each verified entity is digitally certified by the issue of a certificate for use in association with a web address of the verified entity.

3. The system of claim 2 wherein the certificate is an SSL certificate issued by an SSL conforming platform.

4. The system of claim 2 wherein the certificate is a TLS certificate issued by a TLS platform

5. The system of claim 1 wherein digital certification of each verified entity is signalled by a characterising image.

6. The system of claim 5 wherein the characterising image is displayed in the address bar of a webpage of the website of the verified entity.

7. The system of claim 1 wherein a code snippet is issued to a webpage of the web address; the code snippet, when executed by the browser of the verified entity, implementing an active image for display on the webpage of that verified entity.

8. The system of claim 1 wherein the verifying entities are in a hierarchical structure.

9. The system of claim 1 wherein the step of digital certification includes issue of an entity ID.

10. The system of claim 9 wherein the step of digital certification includes issue of an aspect pass identifier.

11. The system of claim 1 wherein the code snippet includes code which, when executed by the browser of the verified entity, causes display of data in a drop-down table.

12. The system of claim 11 wherein display of data in a drop-down table occurs when a mouse pointer is hovered over the characterising image.

13. The system of claim 11 wherein display of data in a drop-down table occurs when a mouse pointer is hovered over the active image.

14. The system of claim 13 wherein the data in the drop-down table includes the entity ID.

15-20. (canceled)

21. A digital marketplace comprising a website served by a web enabled server in which only entities comprising verified entities in accordance with the system of claim 1 may participate.

22. The system of claim 1 implemented by way of a processor in communication with a memory; the memory containing code which, when executed, performs the function of the issuing system server.

23-28. (canceled)

29. A method of digitally certifying members of an ecosystem; said system comprising a plurality of verifying entities and a plurality of verified entities; the method incorporating steps whereby each verified entity is verified according to at least one aspect of the entity by at least one of the verifying entities; the digitally certified ecosystem further comprising an issuing system server which enables a secure communications mode on a website of a verified entity.

30. The method of claim 29 wherein each verified entity is digitally certified by the issue of a certificate for use in association with a web address of the verified entity.

31. The method of claim 30 wherein the certificate is an SSL certificate issued by an SSL conforming platform.

32. The method of claim 30 wherein the certificate is a TLS certificate issued by a TLS platform

33. The method of claim 29 wherein digital certification of each verified entity is signalled by a characterising image.

34-56. (canceled)
